(19) United States
(12) Patent Application Publication
(10) Pub. No.: US 2023/0334333 A1
(43) Pub. Date: Oct. 19, 2023

(54) METHODS, APPARATUSES, AND SYSTEMS FOR TRAINING MODEL BY USING MULTIPLE DATA OWNERS

(71) Applicant: Alipay (Hangzhou) Information Technology Co., Ltd., Hangzhou (CN)

(72) Inventors: Longfei Zheng, Hangzhou (CN); Li Wang, Hangzhou (CN); Benyu Zhang, Hangzhou (CN)

(73) Assignee: Alipay (Hangzhou) Information Technology Co., Ltd., Hangzhou (CN)

(21) Appl. No.: 18/299,386

(22) Filed: Apr. 12, 2023

(30) Foreign Application Priority Data
Apr. 15, 2022 (CN) 202210397805.9

(51) Int. Cl. G06N 3/098

(52) U.S. Cl. CPC G06N 3/098

(57) ABSTRACT

Embodiments of this specification provide computer-implemented methods, apparatuses, and systems for training a model using multiple data owners. In an example method, a second data owner determines, according to first data, second feature data intersecting the first data. The following main iteration process is performed until an iteration end condition is met: performing, for each training unit by using a first training sample and a second training sample, cooperative training on a first model, a second model, and a third model that participate in training of the training unit. A master server performs federated aggregation on the trained first model and/or third model in each training unit, to obtain a corresponding first global model and/or third global model. The first model is updated according to the first global model and/or the third model is updated according to the third global model.

### CROSS-REFERENCE TO RELATED APPLICATIONS

This application claims priority to Chinese Patent Application No. 202210397805.9, filed on Apr. 15, 2022, which is hereby incorporated by reference in its entirety.

### TECHNICAL FIELD

Embodiments of this specification relate to the field of artificial intelligence technologies, and specifically, to methods, apparatuses, and systems for training a model by using multiple data owners.

### BACKGROUND

With development of artificial intelligence technologies, machine models have been gradually applied to various service application scenarios, for example, risk assessment, audio recognition, and natural language processing. In many cases, multiple data owners (for example, e-commerce companies, courier services companies, and banks) each own different portions of data of training samples used for model training. The multiple data owners generally want to use each other's data together to train the model in a unified way, but do not want to provide their respective data to other data owners in order to prevent their own data from being leaked.

To alleviate the problem of data silos during model training, a method for training a model jointly by using multiple data owners is proposed, for example, federated learning and split learning. According to a model training method with joint training by multiple parties, in a case in which security of respective data of data owners is ensured, the data owners cooperatively train a model by using respective private data.

### SUMMARY

In view of the previous description, embodiments of this specification provide methods, apparatuses, and systems for training a model by using multiple data owners. According to the technical solutions in the embodiments of this specification, in a case in which security of data of each data owner is ensured, model training can be performed by using both horizontally divided data and vertically divided data.

According to an aspect of the embodiments of this specification, a method for training a model by using multiple data owners is provided, where the multiple data owners include multiple first data owners and multiple second data owners, each first data owner has a first model and horizontally divided first data, and each second data owner has a second model and vertically divided second data; and the method includes: determining, by using a PSI (private set intersection) algorithm at each second data owner according to first data owned by each first data owner, second feature data that intersect each piece of first data from second data owned by the second data owner; determining, as one training unit, the first data owned by each first data owner and the second feature data that intersect the first data and that are owned by each second data owner; performing the following main iteration process until a first iteration end condition is met: performing, for each training unit by using at least a part of first data in the training unit as a first training sample and using second feature data that intersect the first training sample and that are owned by each second data owner as a second training sample, cooperative training on a first model of a first data owner that participates in training of the training unit, a second model of each second data owner, and a third model of a slave server that participates in training of the training unit, where the first model and the second model include the first N layers of a neural network model, and the third model includes one or more remaining layers of the neural network model except the first N layers; performing, at a master server, federated aggregation on a trained first model and/or third model obtained from each training unit, to obtain a first global model for the first model and/or a third global model for the third model; and updating the first model according to the first global model and/or updating the third model according to the third global model at each first data owner and/or at each slave server.

According to another aspect of the embodiments of this specification, a method for training a model by using multiple data owners is further provided, where the multiple data owners include multiple first data owners and multiple second data owners, each first data owner has a first model and horizontally divided first data, each second data owner has a second model and vertically divided second data, and the method is performed by the first data owner; and the method includes: providing owned first data to each second data owner, so each second data owner determines, by using a PSI algorithm according to first data owned by each first data owner, second feature data that intersect each piece of first data from second data owned by the second data owner; determining a belonging training unit, where each training unit is determined from the first data owned by each first data owner and the second feature data that intersect the first data and that are owned by each second data owner; performing the following main iteration process until a first iteration end condition is met: performing, in the training unit, cooperative training on a first model of the first data owner by using at least a part of owned first data as a first training sample and combining, as a second training sample, second feature data that intersect the first training sample and that are owned by each second data owner, where a second model of each second data owner and a third model of a slave server participating in training of the training unit are trained in the cooperative training process, the first model of each first data owner and the second model of each second data owner include the first N layers of a neural network model, and the third model includes one or more remaining layers of the neural network model except the first N layers; sending the trained first model to a master server, so the master server performs federated aggregation on the trained first model, or first model and third model obtained from each training unit, to obtain a first global model for the first model, or the first global model and a third global model for the third model; and updating the owned first model according to the first global model received from the master server.

According to another aspect of the embodiments of this specification, a method for training a model by using multiple data owners is further provided, where the multiple data owners include multiple first data owners and multiple second data owners, each first data owner has a first model and horizontally divided first data, each second data owner has a second model and vertically divided second data, and the method is performed by the second data owner; and the method includes: determining, by using a PSI algorithm according to first data owned by each first data owner, second feature data that intersect each piece of first data from second data owned by the second data owner; determining a training unit to which each piece of second feature data belongs, where each training unit is determined from the first data owned by each first data owner and the second feature data that intersect the first data and that are owned by each second data owner; and performing the following main iteration process until a first iteration end condition is met: performing, in the training unit, cooperative training on a second model of the second data owner by using owned second feature data that intersect a first training sample as a second training sample and combining the first training sample with second feature data of each other second data owner, where the first training sample is determined from at least a part of first data in the training unit, a first model of a first data owner that participates in training of the training unit, the second model of each other second data owner, and a third model of a slave server that participates in training of the training unit are trained in the cooperative training, the first model of each first data owner and the second model of each second data owner include the first N layers of a neural network model, and the third model includes one or more remaining layers of the neural network model except the first N layers; where when the training unit obtains the first model, the second model, and the third model through training, the obtained first model and/or third model are federally aggregated at a master server, to obtain a first global model for the first model and/or a third global model for the third model, and the first model is updated according to the first global model and/or the third model is updated according to the third global model at each first data owner and/or each slave server.

According to another aspect of the embodiments of this specification, an apparatus for training a model by using multiple data owners is further provided, where the multiple data owners include multiple first data owners and multiple second data owners, each first data owner has a first model and horizontally divided first data, each second data owner has a second model and vertically divided second data, and the apparatus is applied to the first data owner; and the apparatus includes: a data providing module, configured to provide owned first data to each second data owner, so each second data owner determines, by using a PSI algorithm according to first data owned by each first data owner, second feature data that intersect each piece of first data from second data owned by the second data owner; a training unit determining module, configured to determine a belonging training unit, where each training unit is determined from the first data owned by each first data owner and the second feature data that intersect the first data and that are owned by each second data owner; a cooperative training module, configured to: perform, in the training unit, cooperative training on a first model of the first data owner by using at least a part of owned first data as a first training sample and combining, as a second training sample, second feature data that intersect the first training sample and that are owned by each second data owner, where a second model of each second data owner and a third model of a slave server participating in training of the training unit are trained in the cooperative training process, the first model of each first data owner and the second model of each second data owner include the first N layers of a neural network model, and the third model includes one or more remaining layers of the neural network model except the first N layers; a model sending module, configured to send the trained first model to a master server, so the master server performs federated aggregation on the trained first model, or first model and third model obtained from each training unit, to obtain a first global model for the first model, or the first global model and a third global model for the third model; and a model updating module, configured to update the owned first model according to the first global model received from the master server; where the cooperative training module, the model sending module, and the model updating module are iteratively executed until a first iteration end condition is satisfied.

According to another aspect of the embodiments of this specification, an apparatus for training a model by using multiple data owners is further provided, where the multiple data owners include multiple first data owners and multiple second data owners, each first data owner has a first model and horizontally divided first data, each second data owner has a second model and vertically divided second data, and the apparatus is applied to the second data owner; and the apparatus includes: a feature data determining module, configured to determine, by using a PSI algorithm according to first data owned by each first data owner, second feature data that intersect each piece of first data from second data owned by the second data owner; a training unit determining module, configured to determine a training unit to which each piece of second feature data belongs, where each training unit is determined from the first data owned by each first data owner and the second feature data that intersect the first data and that are owned by each second data owner; and a cooperative training module, configured to: perform, in the training unit, cooperative training on a second model of the second data owner by using owned second feature data that intersect a first training sample as a second training sample and combining the first training sample with second feature data of each other second data owner, where the first training sample is determined from at least a part of first data in the training unit, a first model of a first data owner that participates in training of the training unit, the second model of each other second data owner, and a third model of a slave server that participates in training of the training unit are trained in the cooperative training, the first model of each first data owner and the second model of each second data owner include the first N layers of a neural network model, and the third model includes one or more remaining layers of the neural network model except the first N layers; where when the training unit obtains the first model, the second model, and the third model through training, the obtained first model and/or third model are federally aggregated at a master server, to obtain a first global model for the first model and/or a third global model for the third model, and the first model is updated according to the first global model and/or the third model is updated according to the third global model at each first data owner and/or each slave server; and the cooperative training module is iteratively executed until a first iteration end condition is satisfied.

According to another aspect of the embodiments of this specification, a system for training a model by using multiple data owners is further provided, including a first data owner, a second data owner, a slave server, and a master server, where each first data owner has a first model and horizontally divided first data, and each second data owner has a second model and vertically divided second data; each second data owner determines, by using a PSI algorithm according to first data owned by each first data owner, second feature data that intersect each piece of first data from second data owned by the second data owner; each first data owner determines a training unit to which the first data owner belongs; each second data owner determines a training unit to which each piece of owned second feature data belongs, where each training unit is determined from the first data owned by each first data owner and the second feature data that intersect the first data and that are owned by each second data owner; for each training unit, a first data owner participating in training of the training unit selects at least a part of first data from the first data owned by the first data owner as a first training sample; each second data owner selects, as a second training sample, second feature data that intersect the first training sample and that are owned by each second data owner; and the first data owner and the slave server participating in training of the training unit and each second data owner perform, by using the first training sample and the second training sample, cooperative training on the first model of the first data owner, the second model of each second data owner, and a third model of the slave server, where the first model and the second model include the first N layers of a neural network model, and the third model includes one or more remaining layers of the neural network model except the first N layers; where a first data owner, each second data owner, and a slave server that participate in training of a same training unit perform a sub-iteration process until a second iteration end condition is satisfied; the master server performs, in each round of main iteration process, federated aggregation on a trained first model and/or third model obtained from each training unit, to obtain a first global model for the first model and/or a third global model for the third model; and each first data owner updates the first model according to the first global model in each round of main iteration process; and/or each slave server updates the third model according to the third global model in each round of main iteration process.

According to another aspect of the embodiments of this specification, an electronic device is further provided, including at least one processor, a memory coupled to the at least one processor, and a computer program stored in the memory, where the at least one processor executes the computer program to implement the method for training a model by using multiple data owners as described in any one of the previous description.

According to another aspect of the embodiments of this specification, a computer readable storage medium is further provided, storing a computer program that, when executed by a processor, implements the method for training a model by using multiple data owners as described above.

According to another aspect of the embodiments of this specification, a computer program product is further provided, including a computer program that, when executed by a processor, implements the method for training a model by using multiple data owners as described in any one of the previous description.

### BRIEF DESCRIPTION OF DRAWINGS

Further understanding of the essence and advantages of the embodiments of this specification can be realized by referring to the following accompanying drawings. In the accompanying drawings, similar components or features can have the same reference numerals.

FIG. 1 is a distributed architecture diagram of an example of a system for training a model by using multiple data owners according to embodiments of this specification.

FIG. 2 is a schematic diagram of an example of horizontally divided first data according to embodiments of this specification.

FIG. 3 is a schematic diagram of an example of vertically divided second data according to embodiments of this specification.

FIG. 4 is a schematic diagram of an example of a training sample that includes horizontally divided first data and vertically divided second data according to embodiments of this specification.

FIG. 5 is a flowchart of an example of a method for training a model by using multiple data owners according to embodiments of this specification.

FIG. 6 is a schematic diagram of an example of first data and second feature data after PSI calculation according to embodiments of this specification.

FIG. 7 is a flowchart of an example of model training performed by each training unit according to embodiments of this specification.

FIG. 8 is a flowchart of an example of calculating a model gradient according to embodiments of this specification.

FIG. 9 is a flowchart of an example of a method for training a model by using multiple data owners according to embodiments of this specification.

FIG. 10 is a flowchart of an example of a method for training a model by using multiple data owners according to embodiments of this specification.

FIG. 11 is a block diagram of an example of an apparatus for training a model by using multiple data owners according to embodiments of this specification.

FIG. 12 is a block diagram of an example of an apparatus for training a model by using multiple data owners according to embodiments of this specification.

FIG. 13 is a block diagram of an electronic device configured to implement a method for training a model by using multiple data owners according to embodiments of this specification.

FIG. 14 is a block diagram of an electronic device configured to implement a method for training a model by using multiple data owners according to embodiments of this specification.

### DESCRIPTION OF EMBODIMENTS

The subject matter described here will be discussed below with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the elements under discussion can be changed without departing from the protection scope of the embodiments of this specification. Various processes or components can be omitted, replaced, or added in the examples as needed. In addition, features described for some examples can also be combined in other examples.

As used in this specification, the term “include” and its variant are inclusive, meaning “including but not limited to”. The term “based on” means “based on at least a part”. The terms “one embodiment” and “an embodiment” indicate “at least one embodiment”. The term “another embodiment” indicates “at least one other embodiment”. The terms “first”, “second”, etc. can refer to different objects or the same object. The following can include other definitions, whether explicit or implicit. Unless explicitly stated in the context, the definition of a term is consistent throughout this specification.

With development of artificial intelligence technologies, machine models have been gradually applied to various service application scenarios, for example, risk assessment, audio recognition, and natural language processing. In many cases, multiple data owners (for example, e-commerce companies, courier services companies, and banks) each own different portions of data of training samples used for model training. The multiple data owners generally want to use each other's data together to train the model in a unified way, but do not want to provide their respective data to other data owners in order to prevent their own data from being leaked.

To alleviate the problem of data silos during model training, a method for training a model jointly by using multiple data owners is proposed, for example, federated learning and split learning. According to a model training method with joint training by multiple parties, in a case in which security of respective data of data owners is ensured, the data owners cooperatively train a model by using respective private data.

However, currently, model training can be performed only on horizontally divided or vertically divided data, and model training cannot be performed by using both horizontally divided data and vertically divided data as training samples. Therefore, how to use both horizontally divided data and vertically divided data as training samples to perform model training becomes a problem that needs to be urgently alleviated.

In view of the previous description, embodiments of this specification provide methods, apparatuses, and systems for training a model by using multiple data owners. In the method, second feature data that intersect each piece of first data from second data owned by the second data owner is determined by using a PSI algorithm at each second data owner according to first data owned by each first data owner; the first data owned by each first data owner and the second feature data that intersect the first data and that are owned by each second data owner is determined as one training unit; the following main iteration process is performed until a first iteration end condition is met: performing, for each training unit by using at least a part of first data in the training unit as a first training sample and using second feature data that intersect the first training sample and that are owned by each second data owner as a second training sample, cooperative training on a first model of a first data owner that participates in training of the training unit, a second model of each second data owner, and a third model of a slave server that participates in training of the training unit; at a master server, federated aggregation is performed on a trained first model and/or third model obtained from each training unit, to obtain a first global model for the first model and/or a third global model for the third model; and the first model is updated according to the first global model and/or the third model is updated according to the third global model at each first data owner and/or at each slave server. According to the technical solutions in the embodiments of this specification, in a case in which security of data of each data owner is ensured, model training can be performed by using both horizontally divided and vertically divided data.

The following describes in detail methods, apparatuses, and systems for training a model by using multiple data owners in the embodiments of this specification with reference to the accompanying drawings.

A system for training a model by using multiple data owners (hereinafter referred to as a model training system) provided in the embodiments of this specification can include a first data owner, a second data owner, a slave server, and a master server. Quantities of first data owners and second data owners accessing the model training system can be set. In an example, each first data owner and each second data owner can access the model training system in a pluggable method.

When no second data owner accesses the model training system and multiple first data owners simultaneously access the model training system, because the first data owner has horizontally divided first data, in this case, the model training system can perform federated learning based on the first data of each first data owner. When no first data owner accesses the system and multiple second data owners access the model training system, because the second data owner has vertically divided second data, in this case, the model training system can perform split learning based on the second data of each second data owner. When multiple first data owners and multiple second data owners access the model training system at the same time, in this case, the model training system can perform model training by using both the horizontally divided first data and the vertically divided second data. The following uses an example in which the model training system includes multiple first data owners and multiple second data owners for description.

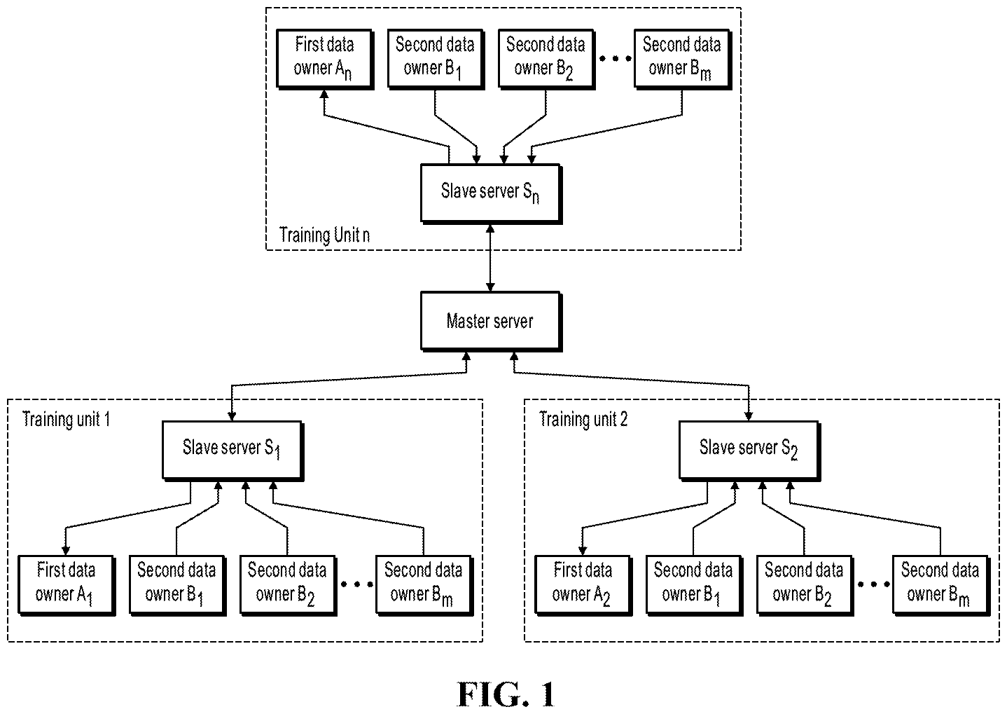

FIG. 1 is a distributed architecture diagram of an example of a system for training a model by using multiple data owners according to embodiments of this specification.

As shown in FIG. 1, the model training system can include multiple first data owners, multiple second data owners, multiple slave servers, and a master server. For example, the model training system can include n first data owners, m second data owners, n slave servers, and one master server. Both n and m are positive integers greater than 1, and n and m can be the same or different.

Multiple first data owners, multiple second data owners, and multiple slave servers in the model training system can form multiple training units, and each training unit is communicatively connected to the master server. Therefore, each training unit can send a trained model to the master server, and the master server can deliver, to each training unit, a global model obtained by federally aggregating the model trained by each training unit, so a model in each training unit is updated.

Each training unit can include one first data owner, each second data owner, and one slave server. First data owners participate in training of different training units are different, and slave servers participate in training of different training units are also different. There are multiple second data owners participating in training of each training unit, and second data owners participating in training of different training units are the same, that is, the multiple second data owners in the model training system participate in model training of all training units. In an example, second data owners participating in training of each training unit can include all second data owners, or can include some second data owners.

FIG. 1 is used as an example. For a training unit i, parties participating in training of the training unit i include a first data owner Aᵢ, m second data owners, and a slave server Sᵢ, where i is an integer greater than 0 and less than or equal to n, and both n and m are positive integers greater than 1.

In the embodiments of this specification, each first data owner has a first model and horizontally divided first data, and each piece of first data includes at least one feature. In an example, each piece of first data can further include a label of a training sample.

Horizontal division means dispersion among multiple data tables according to a certain rule of a certain field, and each data table includes a part of data. For example, horizontal division can be performed according to a user ID, to divide data related to different users into different data tables. Feature spaces of the horizontally divided first data are the same, and sample spaces thereof are different.

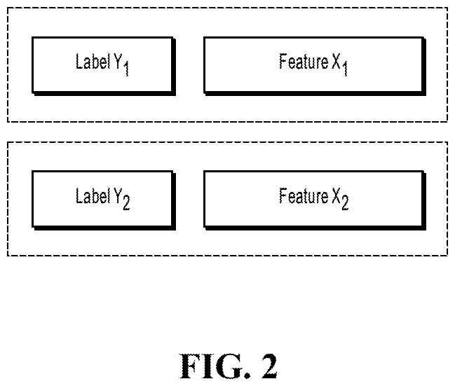

FIG. 2 is a schematic diagram of an example of horizontally divided first data according to embodiments of this specification. As shown in FIG. 2, two pieces of first data are horizontally divided, and each dashed box represents one piece of first data. Each piece of first data that is horizontally divided includes a label and one feature.

In the embodiments of this specification, each second data owner has a second model and vertically divided second data. Vertical division is division performed according to a data feature. Feature spaces of each piece of vertically divided second data are different, and sample spaces thereof are the same. Vertical division can reduce a load on a single database or data table.

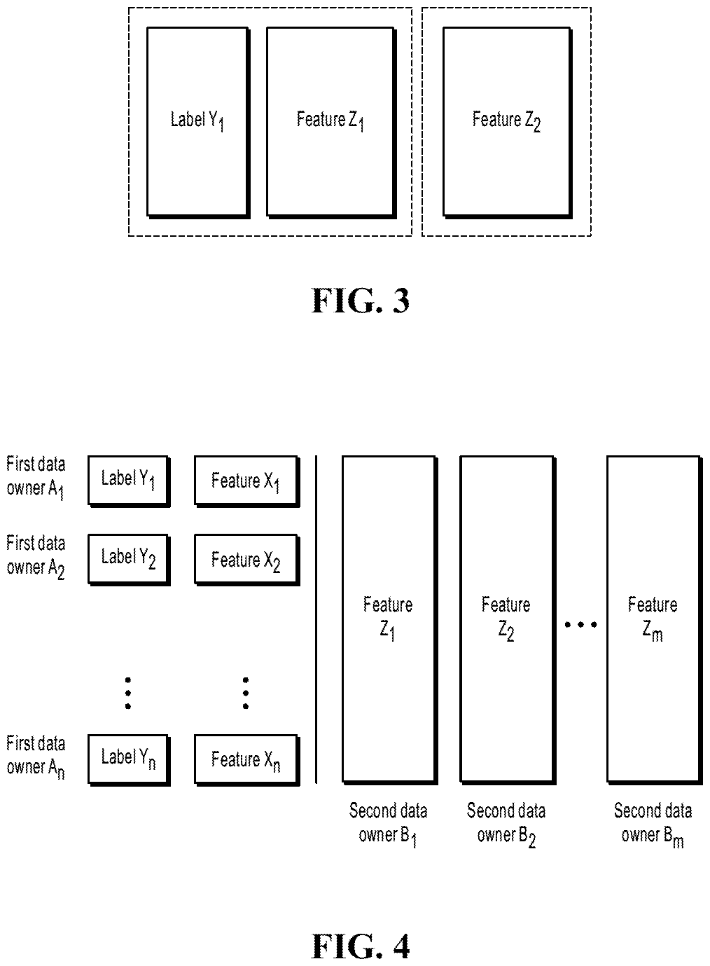

FIG. 3 is a schematic diagram of an example of vertically divided second data according to embodiments of this specification. As shown in FIG. 3, two pieces of second data are vertically divided, and each dashed box represents one piece of second data. Each piece of vertically divided second data includes at least one feature. In an example, each piece of second data can also include a label. When the second data include the label, the first data do not need to include the label of the training sample. The following uses an example in which the first data include the label and the second data do not include the label for description.

In the embodiments of this specification, first data owned by multiple first data owners and second data owned by multiple second data owners that are used for model training are used as training samples, the first data are horizontally divided, and the second data are vertically divided, so a training sample used for model training can be represented as shown in FIG. 4.

FIG. 4 is a schematic diagram of an example of a training sample that includes horizontally divided first data and vertically divided second data according to embodiments of this specification. As shown in FIG. 4, there are n first data owners and m second data owners that are used for model training, and both n and m are positive integers greater than 1. First data that are horizontally divided and that are owned by a first data owner Aᵢ includes a label Yᵢ and a feature Xᵢ, and second data that are vertically divided and that are owned by a second data owner Bⱼ include a feature Zⱼ. In this case, a training sample used for model training includes n pieces of first data that are horizontally divided and m pieces of second data that are vertically divided, where i is an integer greater than or equal to 1 and less than or equal to n, and j is an integer greater than or equal to 1 and less than or equal to m.

In the embodiments of this specification, the first model of each first data owner, the second model of each second data owner, and a third model of each slave server are all neural network models. The first model of each first data owner can include the first N layers of a neural network, and the second model of each second data owner includes the first N layers of a neural network, where N is a positive integer. Each slave server has a third model, and each third model includes one or more remaining layers in the neural network except the first N layers. Each first model and the third model can form a complete neural network model, and each second model and the third model can form a complete neural network model.

In an example, if the first N layers of the neural network include an input layer and a hidden layer, the first model of each first data owner can include the input layer and the hidden layer, and the second model of each second data owner includes the input layer and the hidden layer. Network structures of first models can be the same, and network structures of second models can also be the same. Each third model includes a network layer after the hidden layer. For example, each third model includes an output layer after the hidden layer. The following uses an example in which the first model and the second model include the input layer and the hidden layer, and the third model includes the network layer after the hidden layer for description.

In an example, the first model, the second model, and the third model can be separately used as independent models for training, a first model and a third model that participate in training of a same training unit are communicatively connected, and each second model is separately communicatively connected to the third model. The first model and the third model can jointly complete forward propagation, and each second model can also jointly complete forward propagation with the third model. That is, an output of the first model and an output of each second model that participate in training of the same training unit can be sent to the third model as an input to the third model, so the third model performs subsequent processing thereon, and outputs a processing result, for example, a prediction result.

In another example, a first model and a third model that participate in training of a same training unit can be combined as a complete neural network model used to complete forward propagation. In this example, when participating in training of the training unit, each second model can send an output to the complete neural network model, and the complete neural network model can input, to the network layer after the hidden layer, feature information received from each second model, so as to process, by using the network layer after the hidden layer, the feature information output by each second model, that is, the feature information output by each second model starts to be processed from the network layer after the hidden layer in the complete neural network model.

In an example, the first model, the second model, and the third model can separately run on different physical hosts. In another example, the first model and the third model run on a same physical host. In another example, the third model can run on a same physical host as any second model.

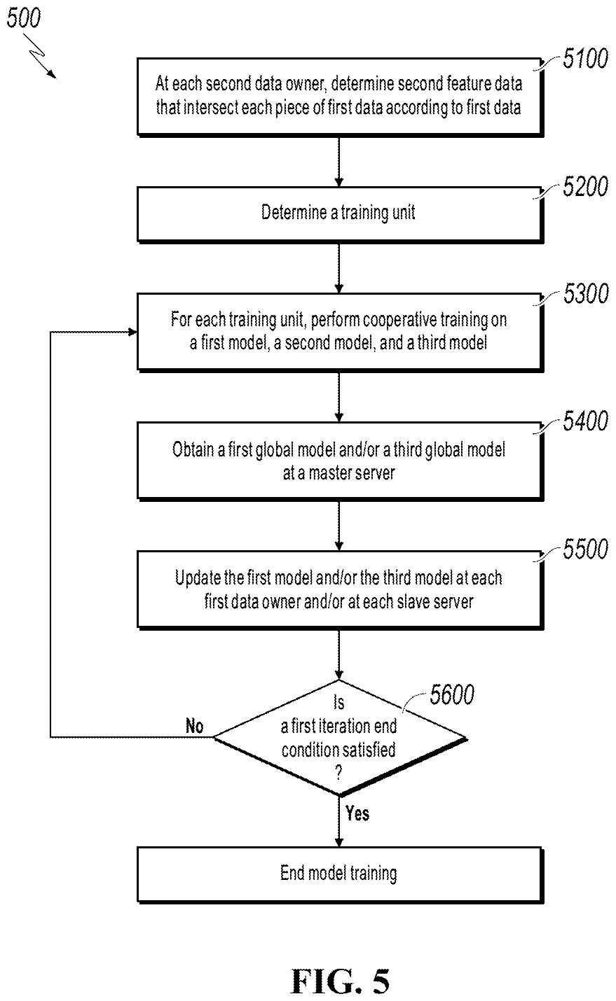

FIG. 5 is a flowchart of an example 500 of a method for training a model by using multiple data owners according to embodiments of this specification.

As shown in FIG. 5, in 5100, at each second data owner, second feature data that intersect each piece of first data can be determined from second data owned by the second data owner by using a private set intersection (PSI) algorithm according to first data owned by each first data owner.

In an example, the PSI algorithm can include at least one of a method based on a same hash function, a method based on Diffie-Hellman key exchange, a method based on oblivious transfer, etc.

For example, if the first data owned by each first data owner includes a user identifier, each first data owner can perform hash calculation on the user identifier in the first data owned by the first data owner, to obtain a corresponding first hash value. Each second data owner can obtain the first hash value that is corresponding to the user identifier and that is generated by each first data owner. Each second data owner can perform hash calculation on a user identifier in each piece of owned second data to obtain a corresponding second hash value. Then, the second data owner can compare the second hash value obtained by calculation with the first hash value from each first data owner, and determine second data to which a second hash value that is the same as the first hash value belongs as second feature data, where the second feature data intersect first data to which the first hash value corresponds.

In the embodiments of this specification, each second data owner can determine, from second data owned by the second data owner, second feature data that intersect each piece of first data, where there are multiple pieces of determined second feature data, each piece of second feature data can be subset data in corresponding second data, and each piece of second feature data intersects different first data. In an example, the determined second feature data are in a same quantity as the first data, and the determined second feature data are in a one-to-one correspondence with the first data.

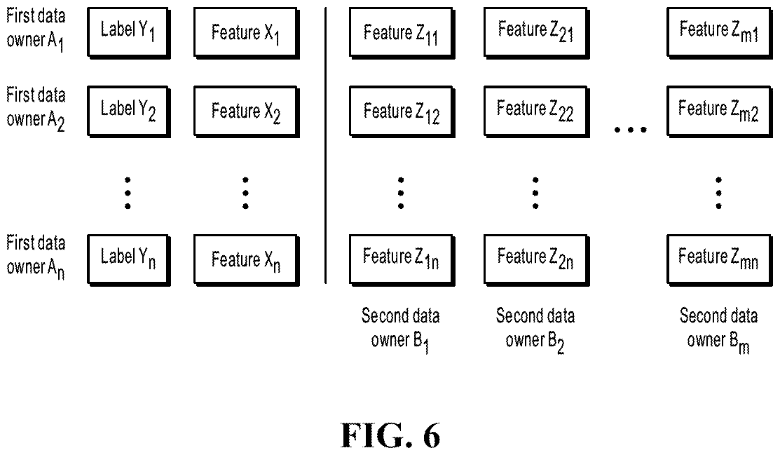

FIG. 6 is a schematic diagram of an example of first data and second feature data after PSI calculation according to embodiments of this specification. As shown in FIG. 6, there are n first data owners, and then there are correspondingly n types of first data. For each second data owner, after the second data owned by the second data owner are intersected with the first data for calculation, n pieces of second feature data intersecting the n types of first data can be determined. In the figure shown in FIG. 6, each piece of second feature data intersects first data that are in the same row of the piece of second feature data. For example, a second data owner B₁ determines that n pieces of second feature data are: Z₁₁, Z₁₂, . . . , and Z₁ₙ, where the second feature data Z₁₁ intersect first data of a first data owner A₁ (that is, includes a label Y₁ and a feature X₁), the second feature data Z₁₂ intersect first data of a first data owner A₂ (that is, includes a label Y₂ and a feature X₂), and the second feature data Z₁ₙ intersect first data of a first data owner Aₙ (that is, includes a label Yₙ and a feature Xₙ).

In 5200, determine, as one training unit, the first data owned by each first data owner and the second feature data that intersect the first data and that are owned by each second data owner.

FIG. 6 is used as an example. In the first data and the second feature data shown in FIG. 6, because each piece of second feature data intersects first data that belongs to a same row, that is, for first data and each piece of second feature data that belong to a same row, the first data separately intersect each piece of second feature data, and the first data and each piece of second feature data that belong to the same row can be determined as one training unit.

In a model training process, training can be performed by using each training unit as a unit, and training between training units is independent of each other, as shown in FIG. 1. Each training unit uses first data of one first data owner, that is, there is only one first data owner participating in training of each training unit, so a quantity of training units is the same as a quantity of first data owners.

Each second data owner participates in training of all training units, and for different training units, second feature data used by each second data owner are different. Second feature data used by each second data owner for each training unit are second feature data that intersect first data used in the training unit. FIG. 6 is used as an example. If the first row shown in FIG. 6 is a training unit 1, the second feature data Z₁₁ of the second data owner B₁ are used for training of the training unit 1, and if the second row is a training unit 2, the second feature data Z₁₂ of the second data owner B₁ are used for training of the training unit 2.

In 5300, perform, for each training unit by using at least a part of first data in the training unit as a first training sample and using second feature data that intersect the first training sample and that are owned by each second data owner as a second training sample, training on a first model of a first data owner that participates in training of the training unit, a second model of each second data owner, and a third model of a slave server that participates in training of the training unit.

In the embodiments of this specification, each training unit can perform an operation in a method of 5300. The following uses one training unit as an example for description.

The model training process provided in the embodiments of this specification can include multiple main iteration processes. When each main iteration process is completed, it is determined whether a first iteration end condition is satisfied, and if the first iteration end condition is satisfied, model training ends. If the first iteration end condition is not satisfied, a next main iteration process continues. Each training unit participates in each main iteration process.

Each training unit includes first data and each piece of second feature data that participate in training of the training unit. In each main iteration process, for each training unit, at least a part of first data can be selected from first data in the training unit as a first training sample. Then, second feature data that intersect the first training sample are determined from second feature data owned by each second data owner, and the determined second feature data are used as a second training sample. The second feature data used as the second training sample are some second feature data in all second training samples that participate in training of the training unit.

In an example, the selected first data used as the first training sample can be all first data that participate in training of the training unit, or can be a part of first data that participate in training of the training unit.

When a part of first data is selected as the first training sample, in an example, the selected part of first data can include first data that have been previously trained as the first training sample and first data that have not been trained as the first training sample. In this example, a part of first data can be selected from all the first data participating in training of the training unit as the first training sample, and a selection method can be random selection.

In another example, the selected part of first data can include only unused first data. The unused first data are first data that are not used in model training as a training sample, and first data that have been used in model training as a training sample are used first data. In this example, the used first data are no longer used in model training. In a selection method of this example, a part of first data can be selected from the unused first data as the first training sample.

In each training unit, by using the first training sample and the second training sample that participate in training of the training unit, training can be performed on the first model of the first data owner that participates in training of the training unit, the second model of each second data owner, and a third model of a slave server that participates in training of the training unit, to obtain a first model, a second model, and a third model that are trained in this round of main iteration process.

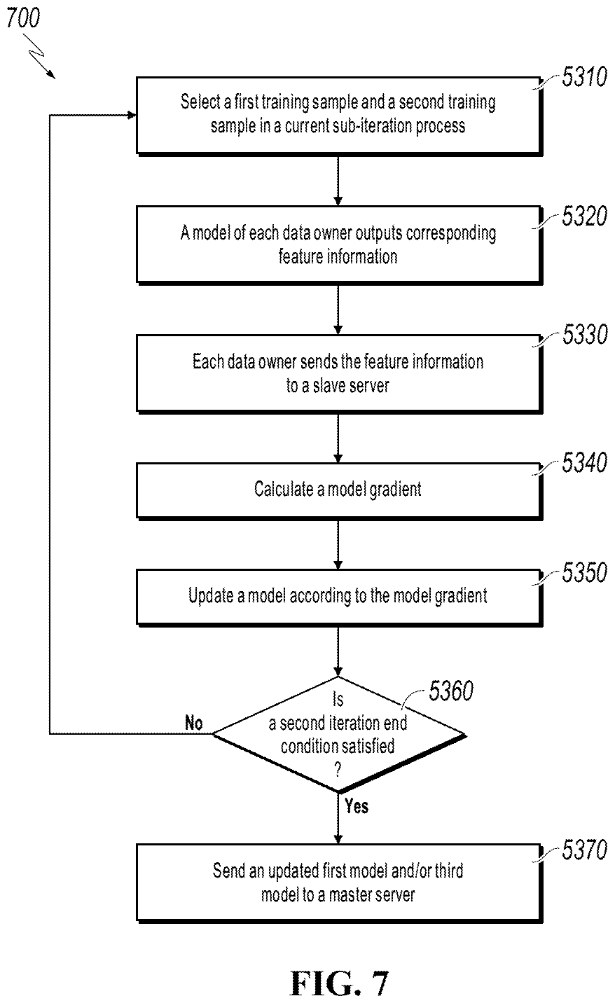

FIG. 7 is a flowchart of an example 700 of model training performed by each training unit according to embodiments of this specification.

As shown in FIG. 7, in 5310, select, from first data owned by a first data owner participating in training of the training unit, at least a part of first data as a first training sample in a current sub-iteration process, and select, from second feature data owned by each second data owner, second feature data that intersect the first training sample as a second training sample in the current sub-iteration process.

In this example, each training unit can perform multiple sub-iterations during each main iteration process. After executing the sub-iteration process for multiple times, each training unit can complete the sub-iteration process to continue to execute the main iteration process shown in FIG. 5. In a main iteration process shown in FIG. 5, quantities of times of sub-iteration processes executed by training units are the same, and quantities of times of sub-iteration processes executed by training units can be specified.

For each training unit, a second iteration end condition can be used as an iteration condition of the sub-iteration process, and it is determined, in each round of sub-iteration process, whether the second iteration end condition is satisfied, and if the second iteration end condition is not satisfied, a next sub-iteration process is continued. If the second iteration end condition is satisfied, the sub-iteration process is completed, and the main iteration process shown in FIG. 5 continues to be executed.

In each sub-iteration process shown in FIG. 7, for each training unit, at least a part of first data can be selected from first data owned by a first data owner participating in training of the training unit as a first training sample in a current sub-iteration process. In an example, at least a part of first data can be first data of one batch, and a quantity of one batch can be specified. A same quantity of first data can be used as the first training sample in each sub-iteration process. In addition, second feature data that intersect the first training sample are selected from the second feature data owned by each second data owner as the second training sample in the current sub-iteration process. When the selected first data used as the first training sample are unused first data, the second feature data used as the second training sample in the current sub-iteration process are also unused second feature data.

The first training sample and the second training sample that are used in each sub-iteration process can be different. In an example, in each sub-iteration process, the first training sample used can have same first data as a first training sample used in a previous round of iteration process, and the second training sample used can have same second data as a second training sample used in the previous round of iteration process.

In 5320, separately input the first training sample in the training unit and the second training sample of each second data owner into a model owned by a respective data owner, to obtain feature information output by each model.

In an example, a first data owner that owns a first training sample can input the first training sample into a first model of the first data owner, where the first N layers of a neural network included in the first model process the input first training sample in a forward propagation method, and outputs first feature information corresponding to the first training sample. Correspondingly, for each second data owner participating in training of the training unit, the second data owner can input an owned second training sample into a second model of the second data owner, and the first N layers of a neural network included in the second model process the input second training sample in a forward propagation method, and output second feature information corresponding to the second training sample.

In 5330, encrypt and send the obtained feature information at each data owner participating in training of the training unit to a slave server participating in training of the training unit.

In an example, an encryption method can include at least one method such as differential privacy encryption, secret sharing, or homomorphic encryption. Different data owners can use different encryption methods, or can use a same encryption method. For feature information at different data owners, an encryption operation can be performed by a data owner that generates the feature information.

After each data owner sends its own encrypted feature information to a slave server participating in training of the training unit, the slave server can obtain feature information from each data owner.

In 5340, calculate a model gradient for the training unit based on a third model of the slave server participating in the training of the training unit and feature information received from each data owner.

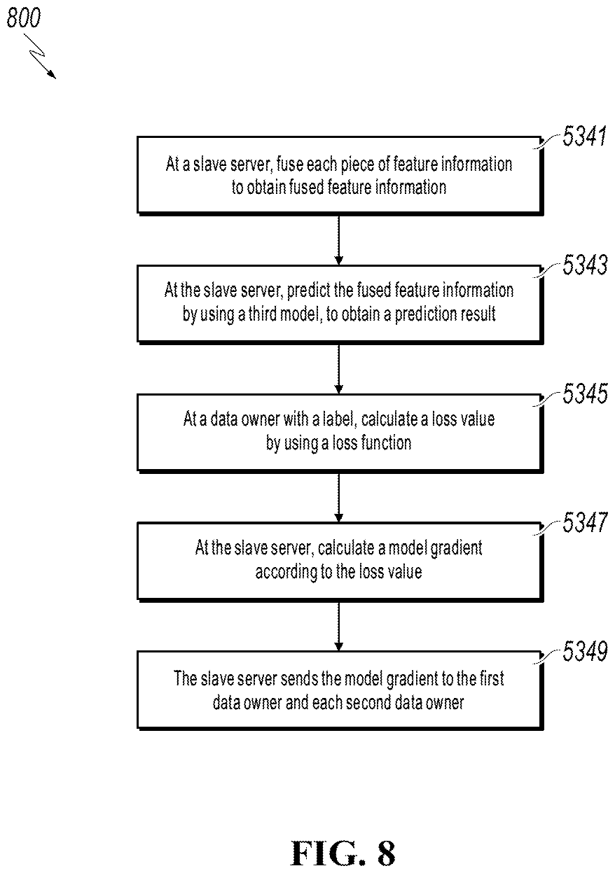

FIG. 8 is a flowchart of an example 800 of calculating a model gradient according to embodiments of this specification.

As shown in FIG. 8, in 5341, at a slave server participating in training of a training unit, feature information received from each data owner can be fused to obtain fused feature information.

In this example, a fusion method can include at least one of summation, mean-pooling, max-pooling, etc.

In 5343, at the slave server, predict the fused feature information by using an owned third model, to obtain a prediction result.

The third model has a network layer after the first N layers of a neural network, the slave server inputs the fused feature information into the third model, and the third model performs forward propagation on the fused feature information, so as to predict the fused feature information and output the prediction result. The slave server can send the prediction result to a data owner that participates in training of a same training unit and that has a label.

In 5345, calculate, at a data owner that participates in training of the training unit and that has a label, a loss value by using a loss function based on a label of a first training sample that participates in this round of training and the prediction result from the slave server.

A data owner that participates in training of the training unit and that has a label has a label corresponding to the owned data, so a label corresponding to data that are used as a training sample and that participate in this round of training can be selected from the owned label, and the selected label is used to evaluate accuracy of the prediction result. In an example, in each training unit, a data owner with a label is a first data owner. Having a label of each piece of owned first data enables selecting a label of first data that are used as a first training sample and that participate in this round of training from the owned label, where the selected label is used to evaluate accuracy of the prediction result.

The used loss function can include any one of an absolute value loss function, a logarithmic loss function, an average loss function, an exponential loss function, a cross entropy loss function, etc. The loss value obtained by means of calculation is used to indicate a gap between a prediction result of a current round of training and a corresponding label. A larger gap indicates a worse prediction effect of a current model, and a smaller gap indicates a better prediction effect of the current model.

After calculating a loss value, a data owner with a label can send the loss value to a slave server participating in training of a same training unit.

In 5347, at the slave server, a model gradient can be calculated based on the loss value received from the data owner.

The slave server calculates the model gradient in a backward propagation method by using the loss value, and in one example, the slave server can calculate the model gradient by using a chain rule.

The calculated model gradient can include a parameter adjustment amount corresponding to each parameter in the first model, a parameter adjustment amount corresponding to each parameter in the second model, and a parameter adjustment amount corresponding to each parameter in the third model.

In 5349, send the model gradient to the first data owner and each second data owner that participate in training of the training unit.

In another example of calculating the model gradient, the model gradient can be calculated at the slave server participating in training of the training unit based on the third model of the slave server and feature information received from each data owner.

In this example, the slave server can obtain, from a first data owner participating in training of the training unit, a label of a first training sample participating in this round of training. Therefore, after outputting a prediction result, the third model of the slave server can use the loss function to calculate a loss value based on a locally stored label of the first training sample and the prediction result. The model gradient is then calculated according to the loss value.

In this example, in a method of obtaining the label of the first training sample by the slave server, when selecting the first training sample, the first data owner sends the label corresponding to the first training sample to the slave server. In another method, before calculating the loss value by using the loss function, the slave server requests the label corresponding to the first training sample from the first data owner.

Returning to FIG. 7, in 5350, update, according to the model gradient, respective owned models at each data owner and the slave server participating in training of the training unit.

In an example, at the slave server, the model parameter in the third model is updated by using the parameter adjustment amount of the third model in the model gradient, to obtain an updated third model. At the first data owner, the model parameter in the first model is updated by using the parameter adjustment amount of the first model in the model gradient, to obtain an updated first model. At each second data owner, the model parameter in the second model is updated by using the parameter adjustment amount of the second model in the model gradient, to obtain an updated second model.

After the first model, each second model, and the third model that participate in training of the training unit are updated, a current sub-iteration process is completed.

In 5360, determine whether a second iteration end condition is satisfied. If the second iteration end condition is satisfied, an operation of 5370 is performed. If the second iteration end condition is not satisfied, an operation of 5310 is performed again, that is, a next sub-iteration process is entered.

The second iteration end condition can include at least one of the following conditions: A quantity of times of sub-iteration iteration reaches a first specified quantity threshold, total duration of sub-iteration iteration reaches specified duration, etc.

In 5370, send the updated first model and/or third model to a master server.

The slave server can obtain the locally updated third model, and can further obtain the updated first model from the first data owner. Therefore, the slave server can send the updated first model and/or third model to the master server, so as to implement federated learning on the first model of each first data owner participating in training of different training units, and federated learning on the third model of each slave server participating in training of different training units.

Each training unit sends a same type of model to the master server. When the training unit sends only the first model to the master server, all other training units also send only first models obtained by means of training to the master server, so the master server subsequently performs federated aggregation only for the first models. When the training unit sends only the third model to the master server, other training units also send only third models obtained by means of training to the master server, so the master server subsequently performs federated aggregation only for the third models. When the training unit sends the first model and the third model to the master server, other training units also send first models and third models that are obtained by means of training to the master server, so the master server subsequently separately performs federated aggregation for the first models and the third models.

In addition, each second data owner participates in training of all training units. Therefore, a model parameter of the second model of each second data owner can be shared among the training units, so as to implement joint model training by using the vertically divided second data.

Returning to FIG. 5, each training unit sends a trained first model and/or third model to the master server. Then, in 5400, perform, at the master server, federated aggregation on the trained first model and/or third model obtained from each training unit, to obtain a first global model for the first model and/or a third global model for the third model.

In the embodiments of this specification, performing federated aggregation on models is performing aggregation calculation on a same type of parameters in a same type of models, to obtain an aggregation value for this type of parameters. The aggregation value can be used as a value of this type of parameters in a corresponding global model. A federated aggregation method can include at least one of a method of parameter summation, parameter mean-pooling, parameter max-pooling, etc.

The first global model can be obtained by federally aggregating the first model trained by each training unit, so the first global model includes a feature space for each first model. The third global model is obtained by federally aggregating the third model trained by each training unit, so the third global model includes a feature space for each third model.

In an example, the training unit that sends the first model and/or the third model to be federally aggregated to the master server can include all training units that participate in model training, or can include only some training units that participate in model training.

In an example, the master server can perform federated aggregation in a synchronous method, that is, the master server performs federated aggregation on received models after receiving models sent by all training units participating in federated aggregation. In another example, the master server can perform federated aggregation in an asynchronous method, that is, the master server can first perform federated aggregation on some received models after receiving models sent by some training units participating in federated aggregation. After models sent by other training units are subsequently received, federated aggregation is performed on the some subsequently received models.

In an example, when data distribution of first data owned by first data owners is even, at the master server, federated aggregation is performed on the trained first model and third model obtained from each training unit, to obtain the first global model for the first model and the third global model for the third model. Even data distribution can include even data feature distribution and even label distribution.

For even data feature distribution, even data distribution is that most of or all of features included in the first data owned by the first data owners are the same. In an example, a method of determining that most of the features are the same can be determining according to a proportion of same features in the first data owned by the first data owners. The proportion can be obtained by dividing all features in the first data by the same features in the first data. When the proportion exceeds a specified proportion threshold, it can be considered that the data features are evenly distributed; otherwise, it is considered that the data features are not evenly distributed. A same feature here is a same feature between first data owned by the first data owners. For example, the specified proportion threshold is 50%. When the proportion of the same features in the first data owned by the first data owners in all the features exceeds 50%, it can be considered that the data features of the first data owners are evenly distributed.

For even label distribution, even label distribution is that most of or all of labels owned by first data owners are the same. Correspondingly, if the labels owned by the first data owners are different or only a small part of labels are the same, it can be considered that the labels are not evenly distributed. For example, labels owned by the first data owner A₁ are all financial fraud labels, and labels owned by the first data owner A₂ include only a small part of financial fraud labels, and further include other labels. It can be considered that the labels of the first data owners A₁ and A₂ are unevenly distributed.

In an example of label distribution, a method of determining that most of labels are the same can be determining according to a proportion of same features in labels owned by the first data owners, and the proportion can be obtained by dividing a quantity of all the owned labels by a quantity of the same labels. When the proportion exceeds a specified proportion threshold, it can be considered that the labels are evenly distributed; otherwise, it is considered that the labels are unevenly distributed.

In another example, when data distribution of the first data owned by each first data owner is uneven, at the master server, federated aggregation is performed on the trained first model or third model obtained from each training unit, to obtain the first global model for the first model or the third global model for the third model.

A model updated by means of federated aggregation can be determined according to an application scenario, and different models can be updated in a targeted method by means of federated aggregation in different application scenarios. For example, in an application scenario of convolutional neural networks (CNNs), when data distribution of the first data owned by each first data owner is uneven, at the master server, federated aggregation is performed on the trained first model obtained from each training unit, to obtain the first global model for the first model. In an application scenario of graph neural networks (GNNs), when data distribution of the first data owned by each first data owner is uneven, at the master server, federated aggregation is performed on the trained third model obtained from each training unit, to obtain the third global model for the third model.

The trained model from each training unit is federally aggregated, so federated learning can be performed by using the first data owned by each first data owner, thereby implementing model training by using more training samples in a case in which privacy security of data of each party is ensured, thereby improving a model training effect.

After obtaining the first global model, the master server can deliver the first global model to the first data owner in each training unit. After obtaining the third global model, the master server can deliver the third global model to the slave server in each training unit.

In 5500, update the first model according to the first global model and/or update the third model according to the third global model at each first data owner and/or at each slave server.

Specifically, when receiving the first global model from the master server, each first data owner can update the respective owned first model according to the first global model. When receiving the third global model from the master server, each slave server can update the respective owned third model according to the third global model.

In 5600, determine whether a first iteration end condition is satisfied. If the first iteration end condition is satisfied, model training is ended. If the first iteration end condition is not satisfied, the operation of 5300 is performed again.

The first iteration end condition can include at least one of the following conditions: A quantity of times of main iterations reaches a second specified quantity threshold, total iteration duration of the main iteration reaches specified duration, a model parameter update difference between two adjacent main iterations is less than a first specified threshold, a change rate of model parameters in multiple main iterations of a specified quantities of consecutive times is less than a second specified threshold, etc.

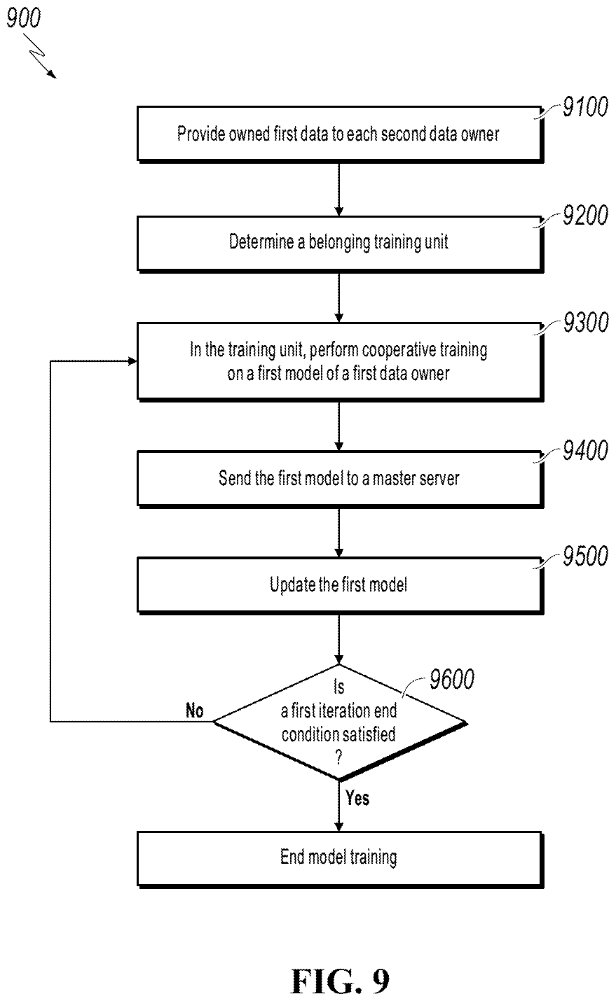

FIG. 9 is a flowchart of an example 900 of a method for training a model by using multiple data owners according to embodiments of this specification.

In the example shown in FIG. 9, multiple data owners include multiple first data owners and multiple second data owners, each first data owner has a first model and horizontally divided first data, and each second data owner has a second model and vertically divided second data. The method shown in FIG. 9 can be performed by the first data owner.

As shown in FIG. 9, in 9100, provide owned first data to each second data owner, so each second data owner determines, by using a PSI algorithm according to first data owned by each first data owner, second feature data that intersect each piece of first data from second data owned by the second data owner.

In 9200, determine a belonging training unit, where each training unit is determined from the first data owned by each first data owner and the second feature data that intersect the first data and that are owned by each second data owner.

In 9300, perform, in the training unit, cooperative training on a first model of the first data owner by using at least a part of owned first data as a first training sample and combining, as a second training sample, second feature data that intersect the first training sample and that are owned by each second data owner, where a second model of each second data owner and a third model of a slave server participating in training of the training unit are trained in the cooperative training process, the first model of each first data owner and the second model of each second data owner include the first N layers of a neural network model, and the third model includes one or more remaining layers of the neural network model except the first N layers.

In an example, in each training unit, the following sub-iteration process is performed until a second iteration end condition is met: selecting at least a part of first data from the owned first data as a first training sample in a current sub-iteration process; inputting the first training sample into the first model of the first data owner, to obtain feature information output by the first model; encrypting and sending the obtained feature information to a slave server participating in training of the training unit, so the slave server calculates a model gradient according to the feature information output by the first data owner and feature information obtained by the second model of each second data owner based on the input second training sample, where the second training sample of each second data owner is obtained by selecting, from second feature data owned by the second data owner, second feature data that intersect the first training sample; and updating the owned first model according to the model gradient.

In an example, the obtained feature information is encrypted and sent to the slave server participating in training of the training unit, so the slave server fuses the feature information output by the first data owner and the feature information obtained by the second model of each second data owner based on the input second training sample, to obtain fused feature information, and predicts the fused feature information by using the owned third model, to obtain a prediction result; and a loss value is calculated by using a loss function based on a label of a training sample participating in this round of training and the prediction result from the slave server, so the slave server calculates a model gradient according to the loss value and a loss value sent by each second data owner.

In 9400, send the trained first model to a master server, so the master server performs federated aggregation on the trained first model, or first model and third model obtained from each training unit, to obtain a first global model for the first model, or the first global model and a third global model for the third model.

In 9500, update the owned first model according to the first global model received from the master server.

In 9600, determine whether a first iteration end condition is satisfied. If the first iteration end condition is satisfied, model training is ended. If the first iteration end condition is not satisfied, the operation of 9300 is performed again.

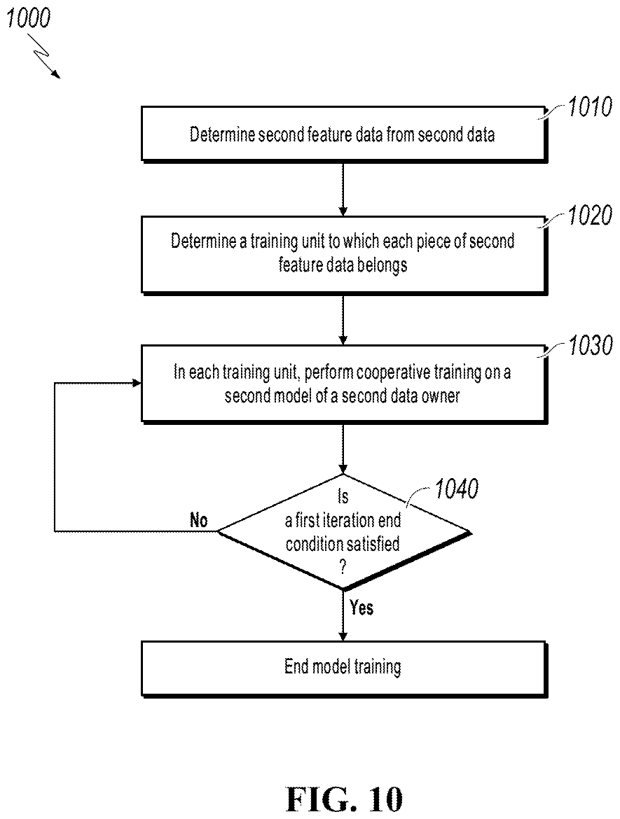

FIG. 10 is a flowchart of an example 1000 of a method for training a model by using multiple data owners according to embodiments of this specification.

In the example shown in FIG. 10, multiple data owners include multiple first data owners and multiple second data owners, each first data owner has a first model and horizontally divided first data, and each second data owner has a second model and vertically divided second data. The method shown in FIG. 10 can be performed by the second data owner.

As shown in FIG. 10, in 1010, determine, by using a PSI algorithm according to first data owned by each first data owner, second feature data that intersect each piece of first data from second data owned by the second data owner.

In 1020, determine a training unit to which each piece of second feature data belongs, where each training unit is determined from the first data owned by each first data owner and the second feature data that intersect the first data and that are owned by each second data owner.

In 1030, perform, in the training unit, cooperative training on a second model of the second data owner by using owned second feature data that intersect a first training sample as a second training sample and combining the first training sample with second feature data of each other second data owner, where the first training sample is determined from at least a part of first data in the training unit, a first model of a first data owner that participates in training of the training unit, the second model of each other second data owner, and a third model of a slave server that participates in training of the training unit are trained in the cooperative training, the first model of each first data owner and the second model of each second data owner include the first N layers of a neural network model, and the third model includes one or more remaining layers of the neural network model except the first N layers;

where when the training unit obtains the first model, the second model, and the third model through training, the obtained first model and/or third model are federally aggregated at a master server, to obtain a first global model for the first model and/or a third global model for the third model, and the first model is updated according to the first global model and/or the third model is updated according to the third global model at each first data owner and/or each slave server.

In 1040, determine whether a first iteration end condition is satisfied. If the first iteration end condition is satisfied, model training is ended. If the first iteration end condition is not satisfied, the operation of 1030 is performed again.

In an example, in a training unit, the following sub-iteration process is performed until a second iteration end condition is met: selecting, from second feature data owned by the second data owner, second feature data that intersect a first training sample as a second training sample, where the first training sample is determined from at least a part of first data selected from first data owned by the first data owner participating in training of the training unit; inputting the second training sample into the second model of the second data owner, to obtain feature information output by the second model; encrypting and sending the obtained feature information to a slave server participating in training of the training unit, so the slave server calculates a model gradient according to the owned third model and feature information received from each data owner; and updating the owned second model according to the model gradient.

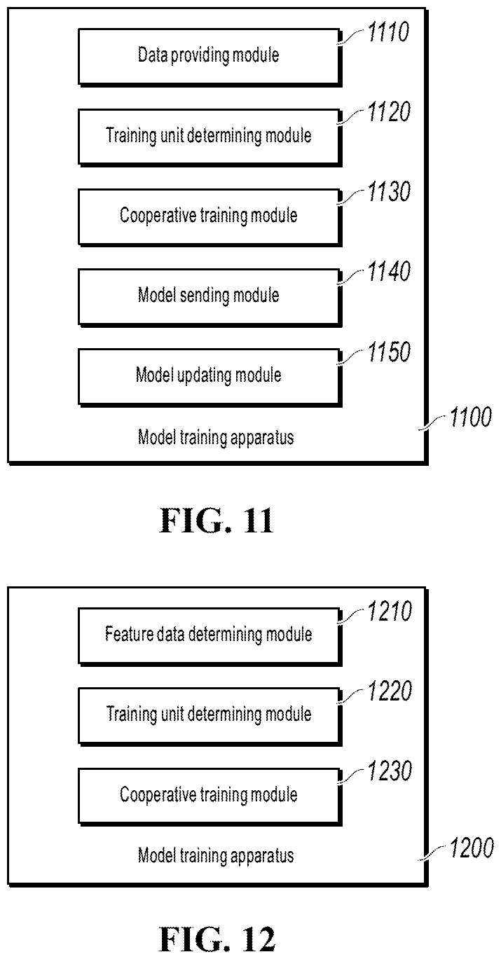

FIG. 11 is a block diagram of an example of an apparatus for training a model by using multiple data owners (hereinafter referred to as a model training apparatus 1100) according to embodiments of this specification.

In the example shown in FIG. 11, multiple data owners include multiple first data owners and multiple second data owners, each first data owner has a first model and horizontally divided first data, and each second data owner has a second model and vertically divided second data. The model training apparatus 1100 can be applied to the first data owner.

As shown in FIG. 11, the model training apparatus 1100 includes a data providing module 1110, a training unit determining module 1120, a cooperative training module 1130, a model sending module 1140, and a model updating module 1150.

The data providing module 1110 can be configured to provide owned first data to each second data owner, so each second data owner determines, by using a PSI algorithm according to first data owned by each first data owner, second feature data that intersect each piece of first data from second data owned by the second data owner.

The training unit determining module 1120 can be configured to determine a belonging training unit, where each training unit is determined from the first data owned by each first data owner and the second feature data that intersect the first data and that are owned by each second data owner.

The cooperative training module 1130 can be configured to: perform, in the training unit, cooperative training on a first model of the first data owner by using at least a part of owned first data as a first training sample and combining, as a second training sample, second feature data that intersect the first training sample and that are owned by each second data owner, where a second model of each second data owner and a third model of a slave server participating in training of the training unit are trained in the cooperative training process, the first model of each first data owner and the second model of each second data owner include the first N layers of a neural network model, and the third model includes one or more remaining layers of the neural network model except the first N layers.

In an example, the cooperative training module 1130 can be further configured to: perform the following sub-iteration process in each training unit until a second iteration end condition is met: selecting at least a part of first data from the owned first data as a first training sample in a current sub-iteration process; inputting the first training sample into the first model of the first data owner, to obtain feature information output by the first model; encrypting and sending the obtained feature information to a slave server participating in training of the training unit, so the slave server calculates a model gradient according to the feature information output by the first data owner and feature information obtained by the second model of each second data owner based on the input second training sample, where the second training sample of each second data owner is obtained by selecting, from second feature data owned by the second data owner, second feature data that intersect the first training sample; and updating the owned first model according to the model gradient.

In an example, the cooperative training module 1130 can be further configured to: encrypt and send the obtained feature information to the slave server participating in training of the training unit, so the slave server fuses the feature information output by the first data owner and the feature information obtained by the second model of each second data owner based on the input second training sample, to obtain fused feature information, and predicts the fused feature information by using the owned third model, to obtain a prediction result; and a loss value is calculated by using a loss function based on a label of a training sample participating in this round of training and the prediction result from the slave server, so the slave server calculates a model gradient according to the loss value and a loss value sent by each second data owner.

The model sending module 1140 can be configured to send the trained first model to a master server, so the master server performs federated aggregation on the trained first model, or first model and third model obtained from each training unit, to obtain a first global model for the first model, or the first global model and a third global model for the third model.

The model updating module 1150 can be configured to update the owned first model according to the first global model received from the master server.

The cooperative training module 1130, the model sending module 1140, and the model updating module 1150 are iteratively executed until a first iteration end condition is satisfied.

FIG. 12 is a block diagram of an example of an apparatus for training a model by using multiple data owners (hereinafter referred to as a model training apparatus 1200) according to embodiments of this specification.

In the example shown in FIG. 12, multiple data owners include multiple first data owners and multiple second data owners, each first data owner has a first model and horizontally divided first data, and each second data owner has a second model and vertically divided second data. The model training apparatus 1200 can be applied to the second data owner.

As shown in FIG. 12, the model training apparatus 1200 includes a feature data determining module 1210, a training unit determining module 1220, and a cooperative training module 1230.

The feature data determining module 1210 can be configured to determine, by using a PSI algorithm according to first data owned by each first data owner, second feature data that intersect each piece of first data from second data owned by the second data owner.

The training unit determining module 1220 can be configured to determine a training unit to which each piece of second feature data belongs, where each training unit is determined from the first data owned by each first data owner and the second feature data that intersect the first data and that are owned by each second data owner.

The cooperative training module 1230 can be configured to: perform, in the training unit, cooperative training on a second model of the second data owner by using owned second feature data that intersect a first training sample as a second training sample and combining the first training sample with second feature data of each other second data owner, where the first training sample is determined from at least a part of first data in the training unit, a first model of a first data owner that participates in training of the training unit, the second model of each other second data owner, and a third model of a slave server that participates in training of the training unit are trained in the cooperative training, the first model of each first data owner and the second model of each second data owner include the first N layers of a neural network model, and the third model includes one or more remaining layers of the neural network model except the first N layers;

where when the training unit obtains the first model, the second model, and the third model through training, the obtained first model and/or third model are federally aggregated at a master server, to obtain a first global model for the first model and/or a third global model for the third model, and the first model is updated according to the first global model and/or the third model is updated according to the third global model at each first data owner and/or each slave server.

The cooperative training module 1230 is iteratively executed until a first iteration end condition is satisfied.

In an example, the cooperative training module 1230 can be further configured to: perform the following sub-iteration process in each training unit until a second iteration end condition is met: selecting, from second feature data owned by the second data owner, second feature data that intersect a first training sample as a second training sample, where the first training sample is determined from at least a part of first data selected from first data owned by the first data owner participating in training of the training unit; inputting the second training sample into the second model of the second data owner, to obtain feature information output by the second model; encrypting and sending the obtained feature information to a slave server participating in training of the training unit, so the slave server calculates a model gradient according to the owned third model and feature information received from each data owner; and updating the owned second model according to the model gradient.

Embodiments of this specification further provide a system for training a model by using multiple data owners (hereinafter referred to as a model training system), where the model training system includes a first data owner, a second data owner, a slave server, and a master server, each first data owner has a first model and horizontally divided first data, and each second data owner has a second model and vertically divided second data.

FIG. 1 is used as an example. An architecture of a model training system that includes multiple first data owners, multiple second data owners, multiple slave servers, and one master server is shown in FIG. 1.

Each second data owner can be configured to determine, by using a PSI algorithm according to first data owned by each first data owner, second feature data that intersect each piece of first data from second data owned by the second data owner.

Each first data owner can be configured to determine a training unit to which the first data owner belongs.

Each second data owner can be configured to determine a training unit to which each piece of owned second feature data belongs, where each training unit is determined from the first data owned by each first data owner and the second feature data that intersect the first data and that are owned by each second data owner.

For each training unit, a first data owner participating in training of the training unit selects at least a part of first data from the first data owned by the first data owner as a first training sample. Each second data owner can be configured to select, as a second training sample, second feature data that intersect the first training sample and that are owned by each second data owner. The first data owner and the slave server participating in training of the training unit and each second data owner can be configured to perform, by using the first training sample and the second training sample, cooperative training on the first model of the first data owner, the second model of each second data owner, and a third model of the slave server, where the first model and the second model include the first N layers of a neural network model, and the third model includes one or more remaining layers of the neural network model except the first N layers; where a first data owner, each second data owner, and a slave server that participate in training of a same training unit perform a sub-iteration process until a second iteration end condition is satisfied.

The master server can be configured to perform, in each round of main iteration process, federated aggregation on a trained first model and/or third model obtained from each training unit, to obtain a first global model for the first model and/or a third global model for the third model; and

each first data owner can be configured to update the first model according to the first global model in each round of main iteration process; and/or each slave server updates the third model according to the third global model in each round of main iteration process.

In an example, for each training unit, a first data owner participating in training of the training unit is configured to select a part of first data from owned unused first data as a first training sample in a current sub-iteration process. Each second data owner is configured to select, as the second training sample in the current sub-iteration process from the owned second feature data, second feature data that intersect the first training sample and that are owned by each second data owner.

The first data owner is configured to input the first training sample into the owned first model, to obtain feature information output by the first model, and encrypt and send the obtained feature information to a slave server participating in training of the training unit. Each second data owner is configured to input the owned second training sample into the owned second model, to obtain feature information output by the second model, and encrypt and send the obtained feature information to the slave server participating in training of the training unit.

The slave server participating in training of the training unit is configured to calculate a model gradient for the training unit based on a third model of the slave server and feature information received from each data owner.

The first data owner participating in training of the training unit is configured to update the first model according to the model gradient. Each second data owner is configured to update the owned second model according to the model gradient. The slave server participating in training of the training unit is configured to update the third model according to the model gradient.

In an example, the slave server participating in training of the training unit is configured to fuse the feature information received from each data owner, to obtain fused feature information; and predict the fused feature information by using the owned third model, to obtain a prediction result.

The first data owner participating in training of the training unit is configured to calculate a loss value by using a loss function based on a label of a first training sample that participates in this round of training and the prediction result from the slave server.

The slave server is configured to calculate the model gradient according to the loss value received from the first data owner, and send the model gradient to the first data owner and each second data owner.

Referring to FIG. 1 to FIG. 12, the embodiments of the method and the apparatus for training a model by using multiple data owners according to embodiments of this specification are described above.

The apparatus for training a model by using multiple data owners in the embodiments of this specification can be implemented by using hardware, or can be implemented by using software or a combination of hardware and software. Software implementation is used as an example. As a logical device, the device is formed by reading a corresponding computer program instruction in a memory to an internal storage by a processor of a device where the device is located. In the embodiments of this specification, for example, the apparatus for training a model by using multiple data owners can be implemented by using an electronic device.

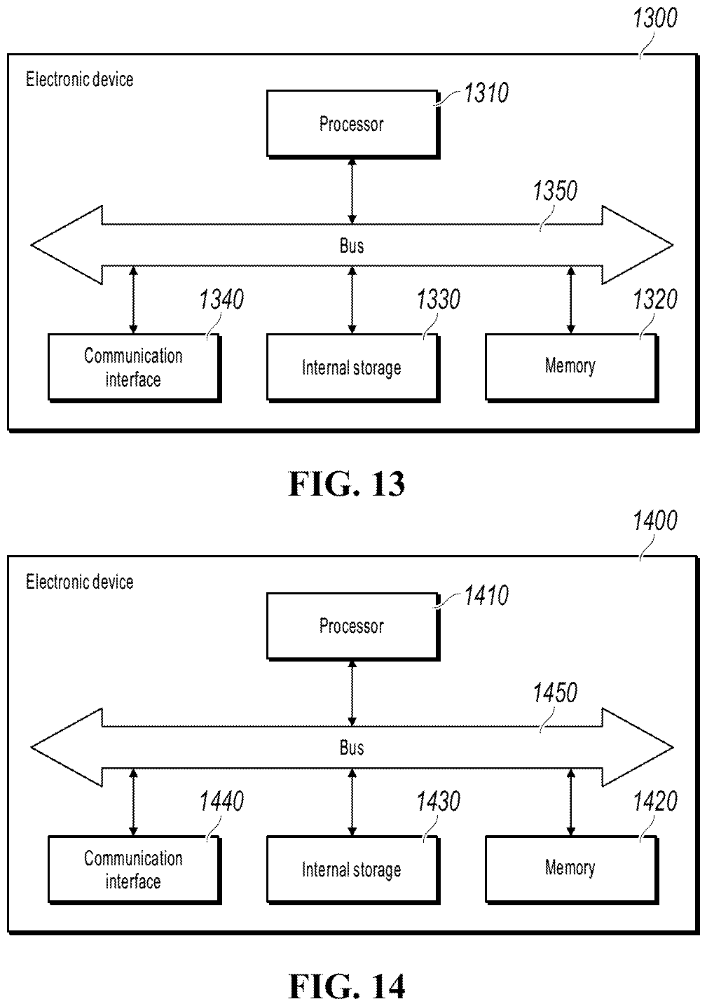

FIG. 13 is a block diagram of an electronic device 1300 configured to implement a method for training a model by using multiple data owners according to embodiments of this specification.

As shown in FIG. 13, the electronic device 1300 can include at least one processor 1310, a memory (for example, a non-volatile memory) 1320, an internal storage 1330, and a communication interface 1340, and the at least one processor 1310, the memory 1320, the internal storage 1330, and the communication interface 1340 are connected together by using a bus 1350. The at least one processor 1310 executes at least one computer readable instruction (that is, the previous element implemented in the form of software) stored or encoded in the memory.

In the embodiments, computer executable instructions are stored in the memory, and when being executed, the computer executable instructions enable the at least one processor 1310 to: provide owned first data to each second data owner, so each second data owner determines, by using a PSI algorithm according to first data owned by each first data owner, second feature data that intersect each piece of first data from second data owned by the second data owner; determine a belonging training unit, where each training unit is determined from the first data owned by each first data owner and the second feature data that intersect the first data and that are owned by each second data owner; perform the following main iteration process until a first iteration end condition is met: performing, in the training unit, cooperative training on a first model of the first data owner by using at least a part of owned first data as a first training sample and combining, as a second training sample, second feature data that intersect the first training sample and that are owned by each second data owner; send the trained first model to a master server, so the master server performs federated aggregation on the trained first model, or first model and third model obtained from each training unit, to obtain a first global model for the first model, or the first global model and a third global model for the third model; and update the owned first model according to the first global model received from the master server.

It should be understood that, when the computer executable instructions stored in the memory are executed, the at least one processor 1310 performs the previous operations and functions described with reference to FIG. 1 to FIG. 12 in the embodiments of this specification.

FIG. 14 is a block diagram of an electronic device 1400 configured to implement a method for training a model by using multiple data owners according to embodiments of this specification.

As shown in FIG. 14, the electronic device 1400 can include at least one processor 1410, a memory (for example, a non-volatile memory) 1420, an internal storage 1430, and a communication interface 1440, and the at least one processor 1410, the memory 1420, the internal storage 1430, and the communication interface 1440 are connected together by using a bus 1450. The at least one processor 1410 executes at least one computer readable instruction (that is, the previous element implemented in the form of software) stored or encoded in the memory.

In the embodiments, computer executable instructions are stored in the memory, and when being executed, the computer executable instructions enable the at least one processor 1410 to: determine, by using a PSI algorithm according to first data owned by each first data owner, second feature data that intersect each piece of first data from second data owned by a second data owner; determine a training unit to which each piece of second feature data belongs, where each training unit is determined from the first data owned by each first data owner and the second feature data that intersect the first data and that are owned by each second data owner; and perform the following main iteration process until a first iteration end condition is met: performing, in the training unit, cooperative training on a second model of the second data owner by using owned second feature data that intersect a first training sample as a second training sample and combining the first training sample with second feature data of each other second data owner, where the first training sample is determined from at least a part of first data in the training unit, a first model of a first data owner that participates in training of the training unit, the second model of each other second data owner, and a third model of a slave server that participates in training of the training unit are trained in the cooperative training; where when the training unit obtains the first model, the second model, and the third model through training, the obtained first model and/or third model are federally aggregated at a master server, to obtain a first global model for the first model and/or a third global model for the third model, and the first model is updated according to the first global model and/or the third model is updated according to the third global model at each first data owner and/or each slave server.

It should be understood that, when the computer executable instructions stored in the memory are executed, the at least one processor 1410 performs the previous operations and functions described with reference to FIG. 1 to FIG. 12 in the embodiments of this specification.

According to the embodiments, a program product such as a machine readable medium is provided. The machine readable medium can have instructions (that is, the previous elements implemented in software form). When the instructions are executed by a machine, the machine performs the previous operations and functions described with reference to FIG. 1 to FIG. 12 in the embodiments of this specification.

Specifically, a system or device equipped with a readable storage medium can be provided, and software program code for implementing a function of any one of the previous embodiments is stored in the readable storage medium, so a computer or a processor of the system or device reads and executes instructions stored in the readable storage medium.

In this case, the program code read from the readable medium can implement a function of any one of the previous embodiments. Therefore, the machine readable code and the readable storage medium that stores the machine readable code constitute a part of this application.

Computer program code needed for operation of each part of this specification can be compiled in any one or more programming languages, including an object-oriented programming language such as Java, Scala, Smalltalk, Eiffel, JADE, Emerald, C++, C#, VB, NET, and Python, a conventional programming language such as C language, Visual Basic 2003, Perl, COBOL 2002, PHP, and ABAP, a dynamic programming language such as Python, Ruby, and Groovy, or another programming language. The program code can run on a user computer, or run as a stand-alone package on the user computer, or partially run on the user computer and partially run on a remote computer, or run on the remote computer or server as a whole. In the latter case, the remote computer can be connected to the user computer in any form of network, such as a local area network (LAN) or a wide area network (WAN), or connected to an external computer (e.g., via the Internet), or in a cloud computing environment, or used as a service, such as software as a service (SaaS).

Embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, a DVD-RW), a magnetic tape, a non-volatile memory card, and a ROM. Optionally, program code can be downloaded from a server computer or cloud by a communication network.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or can be advantageous.

Not all steps and units in the previous processes and system structure diagrams are needed. Some steps or units can be ignored based on actual needs. An execution sequence of each step is not fixed, and can be determined based on needs. The device structure described in the previous embodiments can be a physical structure, or can be a logical structure, that is, some units can be implemented by a same physical entity, or some units can be implemented by multiple physical entities, or can be implemented jointly by some components in multiple independent devices.

The term “example” used throughout this specification means “used as an example, an instance, or an illustration” and does not mean “preferred” or “advantageous” over other embodiments. For the purpose of providing an understanding of the described technology, a specific implementation includes specific details. However, these techniques can be implemented without these specific details. In some examples, well-known structures and devices are shown in block diagrams in order to avoid making it difficult to understand the concepts of the described embodiments.

The previous describes in detail optional implementations of the embodiments of this specification with reference to the accompanying drawings. However, the embodiments of this specification are not limited to specific details in the previous implementations. Within a technical concept scope of the embodiments of this specification, multiple simple variations of the technical solutions of the embodiments of this specification can be made, and these simple variations are all within the protection scope of the embodiments of this specification.

The previous descriptions of this specification are provided to enable any person of ordinary skill in the art to implement or use this specification. It is obvious to a person of ordinary skill in the art that various modifications can be made to this specification. In addition, the general principle defined in this specification can be applied to another variant without departing from the protection scope of this specification. Therefore, this specification is not limited to the examples and designs described here, but is consistent with the widest range of principles and novelty features that conform to the disclosure.

What is claimed is:

1. A computer-implemented method for training a model by using a plurality of data owners, wherein the plurality of data owners comprise a plurality of first data owners and a plurality of second data owners, each first data owner has a respective first model and horizontally divided first data, and each second data owner has a respective second model and vertically divided second data; and the computer-implemented method comprises:
determining, by using a private set intersection (PSI) algorithm at each second data owner according to first data owned by each first data owner, second feature data from second data owned by the second data owner that intersect each piece of first data;
determining, as a training unit, first data owned by a first data owner and respective second feature data that intersect the first data and that are owned by each second data owner;
performing the following main iteration process until a first iteration end condition is met:
performing, for each training unit by using a first training sample and a second training sample, cooperative training on a first model of a first data owner that participates in training of the training unit, the respective second model of the each second data owner, and a third model of a slave server that participates in training of the training unit, wherein:
at least a part of first data in the training unit is used as the first training sample,
a plurality of second feature data that are owned by the plurality of second data owners and that intersect the first training sample are used as the second training sample, and
the respective first model of the each first data owner and the respective second model of the each second data owner comprise first N layers of a neural network model, and the third model comprises one or more remaining layers of the neural network model except the first N layers;
performing, at a master server, federated aggregation on the first model trained from each training unit to obtain a first global model, and/or on the third model trained from each training unit to obtain a third global model; and
updating the respective first model of the each first data owner according to the first global model, and/or updating the third model of the slave server according to the third global model.

2. The computer-implemented method according to claim 1, wherein the performing, for each training unit by using a first training sample and a second training sample, cooperative training on a first model of a first data owner that participates in training of the training unit, the respective second model of the each second data owner, and a third model of a slave server that participates in training of the training unit comprises:
performing the following sub-iteration process for each training unit until a second iteration end condition is met:
selecting, from first data owned by a first data owner participating in training of the training unit, at least a part of the first data as a current first training sample in a current sub-iteration process;
selecting a plurality of second feature data from the plurality of second feature data owned by the plurality of second data owners that intersect the current first training sample as a second training sample in the current sub-iteration process;
separately inputting the first training sample in the training unit and respective second training sample of each second data owner into a model of a respective data owner, to obtain feature information output by each model;
encrypting and sending the feature information at each data owner participating in training of the training unit to a slave server participating in training of the training unit;
calculating a model gradient for the training unit based on the third model of the slave server and the feature information received from each data owner; and
updating, according to the model gradient, respective models at each data owner and the slave server participating in training of the training unit.

3. The computer-implemented method according to claim 2, wherein the calculating a model gradient for the training unit based on the third model of the slave server and the feature information received from each data owner comprises:
fusing, at the slave server participating in training of the training unit, the feature information received from each data owner, to obtain fused feature information; and
predicting the fused feature information by using the third model of the slave server to obtain a prediction result;
calculating, at a data owner that participates in training of the training unit and that has a label, a loss value by using a loss function based on a label of a training sample that participates in this round of training and the prediction result from the slave server; and
calculating, at the slave server, the model gradient according to the loss value received from the data owner, and sending the model gradient to the first data owner and each second data owner.

4. The computer-implemented method according to claim 2, wherein a first model and a third model that participate in training of a same training unit are combined as one complete model used to complete forward propagation.

5. The computer-implemented method according to claim 1, wherein the performing, at a master server, federated aggregation on the first model trained from each training unit to obtain a first global model, and/or on the third model trained from each training unit to obtain a third global model comprises:
in response to that data distribution of a plurality of first data owned by the plurality of first data owners is even, performing, at the master server, federated aggregation on the first model and third model trained from each training unit to obtain the first global model and the third global model.

6. The computer-implemented method according to claim 1, wherein the performing, at a master server, federated aggregation on the first model trained from each training unit to obtain a first global model, and/or on the third model trained from each training unit to obtain a third global model comprises:
in response to that data distribution of a plurality of first data owned by the plurality of first data owners is uneven, performing, at the master server, federated aggregation on the first model or third model trained from each training unit, to obtain the first global model for the first model or the third global model for the third model.

7. The computer-implemented method according to claim 1, wherein the PSI algorithm comprises at least one of a computer-implemented method based on a same hash function, a computer-implemented method based on Diffie-Hellman key exchange, or a computer-implemented method based on oblivious transfer.

8. The computer-implemented method according to claim 1, wherein the first N layers comprise an input layer and a hidden layer, and the one or more remaining layers comprise an input layer after the hidden layer.

9. A computer-implemented method for training a model by using a plurality of data owners, wherein the plurality of data owners comprise a plurality of first data owners and a plurality of second data owners, each first data owner has a respective first model and horizontally divided first data, each second data owner has a respective second model and vertically divided second data, and the computer-implemented method comprises:
providing first data owned by a first data owner to each second data owner, wherein the first data owned by the first data owner are used to determine, using a private set intersection (PSI) algorithm, respective second feature data from second data owned by the each second data owner that intersect the first data;
determining a training unit, wherein the training unit is determined based on the first data owned by the first data owner and the respective second feature data that intersect the first data and that are owned by the each second data owner;
performing the following main iteration process until a first iteration end condition is met:
performing, in the training unit, cooperative training on a first model of the first data owner using a first training sample and a second training sample to obtain a trained first model, wherein:
at least a part of the first data is used as the first training sample, and
a plurality of second feature data that are owned by the plurality of second data owner and that intersect the first training sample are combined as the second training sample,
a second model of each second data owner and a third model of a slave server participating in training of the training unit are trained in the cooperative training, and
the respective first model of each first data owner and the respective second model of the each second data owner comprise first N layers of a neural network model, and the third model comprises one or more remaining layers of the neural network model except the first N layers;
sending the trained first model to a master server, wherein federated aggregation is performed on the trained first model to obtain a first global model, or the federated aggregation is performed on the trained first model and the third model trained from each training unit to obtain the first global model and a third global model for the third model; and
updating the first model of the first data owner according to the first global model received from the master server.

10. The computer-implemented method according to claim 9, wherein the performing, in the training unit, cooperative training on a first model of the first data owner by using a first training sample and a second training sample comprises:
performing the following sub-iteration process in the training unit until a second iteration end condition is met:
selecting at least a part of first data from the first data as a first training sample in a current sub-iteration process;
inputting the first training sample into the first model of the first data owner to obtain feature information output by the first model;
encrypting and sending the feature information to the slave server participating in training of the training unit, wherein a model gradient is calculated according to the feature information and second feature information obtained by the second model of each second data owner based on inputting a respective second training sample, wherein the respective second training sample is obtained by selecting, from respective second feature data owned by the each second data owner, respective second feature data that intersect the first training sample; and
updating the first model according to the model gradient.

11. The computer-implemented method according to claim 10, wherein the encrypting and sending the feature information to a slave server participating in training of the training unit, wherein a model gradient is calculated according to the feature information and second feature information obtained by the second model of each second data owner based on inputting a respective second training sample comprises:
encrypting and sending the feature information to the slave server participating in training of the training unit, wherein the feature information and the second feature information are fused to obtain fused feature information, and the fused feature information is predicted, by using the third model of the slave server, to obtain a prediction result; and
calculating a loss value by using a loss function based on a label of a training sample participating in this round of training and the prediction result from the slave server, wherein the model gradient is calculated according to the loss value and a respective loss value sent by each second data owner.

12. The computer-implemented method according to claim 9, wherein the PSI algorithm comprises at least one of a computer-implemented method based on a same hash function, a computer-implemented method based on Diffie-Hellman key exchange, or a computer-implemented method based on oblivious transfer.

13. The computer-implemented method according to claim 9, wherein the first N layers comprise an input layer and a hidden layer, and the one or more remaining layers comprise an input layer after the hidden layer.

14. A computer-implemented method for training a model by using a plurality of data owners, wherein the plurality of data owners comprise a plurality of first data owners and a plurality of second data owners, each first data owner has a respective first model and horizontally divided first data, each second data owner has a respective second model and vertically divided second data, and the computer-implemented method comprises:
determining, by using a private set intersection (PSI) algorithm according to each piece of first data owned by each first data owner, respective second feature data from second data owned by the second data owner that intersect the each piece of first data;
determining a training unit to which of the respective second feature data belongs, wherein the training unit is determined based on first data owned by a first data owner and second feature data that intersects the first data and that are owned by the second data owner; and
performing the following main iteration process until a first iteration end condition is met:
performing, in the training unit, cooperative training on a second model of the second data owner by using owned second feature data that intersect a first training sample as a second training sample and combining the first training sample with second feature data of each other second data owner, wherein:
the first training sample is determined from at least a part of the piece of first data in the training unit,
a first model of a first data owner that participates in training of the training unit, a second model of the each other second data owner, and a third model of a slave server that participates in training of the training unit are trained in the cooperative training, and
the respective first model of the each first data owner and the respective second model of the each second data owner comprise first N layers of a neural network model, and the third model comprises one or more remaining layers of the neural network model except the first N layers;
wherein, after training using a plurality of training units,
a plurality of first models are federally aggregated at a master server to obtain a first global model, and/or a plurality of third models are federally aggregated at the master server to obtain a third global model, and
the respective first model of the each first data owner is updated according to the first global model, and/or the third model of the slave server is updated according to the third global model.

15. The computer-implemented method according to claim 14, wherein the performing, in the training unit, cooperative training on a second model of the second data owner by using owned second feature data that intersects a first training sample as a second training sample and combining the first training sample with second feature data of each other second data owner comprises:
performing the following sub-iteration process in the training unit until a second iteration end condition is met:
selecting, from second feature data owned by the second data owner, second feature data that intersects a first training sample as a second training sample, wherein the first training sample is determined from at least a part of first data selected from first data owned by the first data owner participating in training of the training unit;
inputting the second training sample into the second model of the second data owner, to obtain feature information output by the second model;
encrypting and sending the feature information to the slave server participating in training of the training unit, wherein a model gradient is calculated according to the third model of the slave server and feature information received from each data owner; and
updating the second model according to the model gradient.

16. The computer-implemented method according to claim 14, wherein the PSI algorithm comprises at least one of a computer-implemented method based on a same hash function, a computer-implemented method based on Diffie-Hellman key exchange, or a computer-implemented method based on oblivious transfer.

17. The computer-implemented method according to claim 14, wherein the first N layers comprise an input layer and a hidden layer, and the one or more remaining layers comprise an input layer after the hidden layer.
